(19) United States
(12) Patent Application Publication
(10) Pub. No.: US 2010/0330422 A1
(43) Pub. Date: Dec. 30, 2010

(54) Unit Cell for Secondary Battery Having Conductive Sheet Layer and Lithium Ion Secondary Battery Having the Same

(75) Inventors: Young Jae Kim, Chungju-si (KR); Gyu Sik Kim, Cheongwon-gun (KR); Won Sob Eom, Chungju-si (KR); Jong Man Woo, Chungju-si (KR)

Correspondence Address: REINHART BOERNER VAN DEUREN P.C., 2215 PERRYGREEN WAY, ROCKFORD, IL, 61107, US

(73) Assignee: Enertech International, Incorporated, Chungju-si (KR)

(21) Appl. No.: 12/550,035

(22) Filed: Aug. 28, 2009

(30) Foreign Application Priority Data
Jun. 24, 2009 (KR) 2009-56406

(51) Int. Cl. H01M 4/58

(52) U.S. Cl. 429/220; 429/231.95; 429/221; 429/223; 429/225; 429/229; 429/231.5

(57) ABSTRACT

Disclosed herein is a unit cell for a lithium ion secondary battery, which includes an electrode laminate formed in such a manner that a plurality of unit structures are stacked, each of which includes and least one electrode and at least one separation layer; and at least one conductive sheet layer located between certain layers in the electrode laminate and electrically connected to an electrode lead. The conductive sheet layer of the unit cell for the lithium ion secondary battery rapidly conducts current to the outside or generates heat in quantity smaller than the quantity of heat generated in positive and negative electrodes when short-circuit occurs due to a physical or electrical impact applied to the battery. Accordingly, it is possible to reduce the risk of firing or explosion due to the physical or electrical impact to improve the safety of the lithium ion secondary battery.

### CROSS-REFERENCE TO RELATED PATENT APPLICATIONS

This patent application claims the benefit of co-pending Korean Patent Application No. 2009-56406, filed Jun. 24, 2009, the entire teachings and disclosure of which are incorporated herein by reference thereto.

### BACKGROUND OF THE INVENTION

1. Field of the Invention

The present invention relates to a unit cell for a secondary battery having a conductive sheet layer and a lithium ion secondary battery using the same, and more particularly, to a secondary battery unit cell which has at least one additional conductive sheet layer formed between specific layers in the unit cell to reduce the risk of firing or explosion caused by an electrical shock and a lithium ion secondary battery using the same.

2. Background of the Related Art

Generally, a nickel-cadmium battery, nickel-hydrogen battery, nickel-zinc battery, lithium ion secondary battery, etc. are used as batteries of electronic products and the lithium ion secondary battery is most widely used due to its long lifetime and large capacity. The lithium ion secondary battery is classified by electrolyte type into a lithium metal battery using a liquid electrolyte, a lithium ion battery, and a lithium polymer battery using a polymer solid electrolyte. And then, the lithium polymer battery is classified into a perfect solid lithium polymer battery having no organic electrolytic solution and a lithium ion polymer battery using a gel polymer electrolyte containing an organic electrolytic solution according to polymer solid electrolyte type. Furthermore, the lithium ion secondary battery can be classified into a cylindrical battery, a rectangular battery and a pouch type battery by the type of the external case accommodating a unit cell.

With the recent development of information telecommunication industry and industry of transportation means (HEV, EV, LEV, etc.) driven by battery power, demand for the lithium ion secondary battery remarkably increases. Thus studies on the lithium ion secondary battery capable of meeting the demand are actively being carried out and one of the main subject of this field is improving the safety of the lithium ion secondary battery.

FIG. 1 is an exploded perspective view of a conventional pouch type lithium ion secondary battery 100 using an electrode laminate 200, and FIG. 2 is a cross-sectional view of the electrode laminate 200 for a lithium ion secondary battery. Referring to FIGS. 1 and 2, the electrode laminate 200 is manufactured in such a manner that a positive electrode 220 and a negative electrode 230 are respectively enveloped in a separation layer 210 and integrated with each other through a winding process or the separation layer 210, the positive electrode 220 and the negative electrode 230 are sequentially stacked in a specific area through a stacking process. The electrode laminate 200 is mounted in a receiving part 310 of a pouch 300, and then a lid 320 covers the electrode laminate 200. Here, an electrode tap 500 is connected to an electrode lead 400 for connecting the positive and negative electrodes of the electrode laminate 200 to an external device. The electrode laminate 200 to which the electrode lead 200 and the electrode tap 500 are connected is mounted in the pouch 300 and covered with the lid 320, and then the pouch 300 is filled with an electrolyte and sealed up to accomplish the lithium ion secondary battery 100.

The electrode structure which is formed through the winding or stacking process includes the separation layer 210 interposed between the positive electrode 220 and the negative electrode 230 and is repeatedly stacked to accomplish the single electrode laminate 200. The separation layer 210 prevents the positive electrode and the negative electrode from short-circuiting when the lithium ion secondary battery 100 filled with the electrolyte is activated. Pores in the separation layer 210 function as passages through which lithium ions pass when the lithium ion secondary battery 100 is charged/discharged.

Devices using the lithium ion secondary battery may be exposed to a shock, heat, over-charging, over-discharging, short-circuit, penetration, compression, etc. through the behavior of a final user and environment in which the devices are used. This brings about a damages to the lithium ion secondary battery, to cause firing, exploding of the lithium ion secondary battery. Most lithium ion secondary batteries are manufactured in consideration of such a safety aspect. Although the quantity of energy stored in the lithium ion secondary battery increases as the capacity of the lithium ion secondary battery increases at the user's request, the safety of the lithium ion secondary battery is deteriorated as energy density increases. When the lithium ion secondary battery is pierced or compressed, or a shock is applied to the lithium ion secondary battery, the separation layer in the unit cell of the lithium ion secondary battery is damaged due to a physical force to result in short-circuit of the negative electrode and the positive electrode. When the short-circuit occurs, the inner current of the battery and electrode active materials react to each other to generate heat energy, and thus the temperature of battery abruptly increases to result in firing or explosion of the lithium ion secondary battery.

Accordingly, the Applicants propose a unit cell which includes electrodes, a separation layer, an electrode lead, and an additional metal sheet layer to minimize generation of heat due to penetration, shock, compression and other electrical impacts.

### SUMMARY OF THE INVENTION

Accordingly, the present invention has been made in view of the above-mentioned problems in the prior art, and it is a primary object of the present invention to provide a unit cell for a lithium ion secondary battery, which reduces the risk of firing or explosion caused by physical and electrical shocks.

It is another object of the present invention to provide a lithium ion secondary battery using the unit cell.

To accomplish the above object of the present invention, there is provided a unit cell for a lithium ion secondary battery, which includes (A) an electrode laminate formed in a manner that a plurality of unit structures are stacked, each of which includes at least one electrode and at least one separation layer; (B) and at least one conductive sheet layer located between certain layers in the electrode laminate and electrically connected to an electrode lead.

The conductive sheet layer may be made of at least one metal selected from a group consisting of aluminum, copper, nickel, iron, zinc, lead and titanium. The conductive sheet layer may be made of aluminum when the conductive sheet layer comes into contact with a positive electrode and the conductive sheet layer may be made of copper when the conductive sheet layer comes into contact with a negative electrode. The conductive sheet layer may have a thickness in the range of 0.001 to 200 mm.

The unit cell may include two or more conductive sheet layers and the conductive sheet layers may be respectively located between the uppermost separation layer and uppermost electrode and between the lowermost separation layer and lowermost electrode. In this case, the two or more conductive sheet layers may be electrically connected at the side opposite to the electrode lead.

The conductive sheet layer of the unit cell for the lithium ion secondary battery of the present invention conducts current rapidly to the outside or lower the heat generation during the battery's short-circuiting caused by physical or electrical impact applied to the battery. Accordingly, it is possible to reduce the risk of firing or explosion due to the physical or electrical impact, and to improve the safety of the lithium ion secondary battery.

### BRIEF DESCRIPTION OF THE DRAWINGS

The above and other objects, features and advantages of the present invention will be apparent from the following detailed description of the preferred embodiments of the invention in conjunction with the accompanying drawings, in which:

FIG. 1 is an exploded perspective view of a pouch type lithium ion secondary battery;

FIG. 2 is a cross-sectional view of an electrode laminate for a conventional lithium ion secondary battery;

FIGS. 3a through 3f are cross-sectional views of electrode laminate having a conductive sheet layer located between certain layers according to the present invention; and

FIG. 4 shows a unit cell which includes the electrode laminate shown in FIG. 3a and is connected to an electrode lead and an electrode tap.

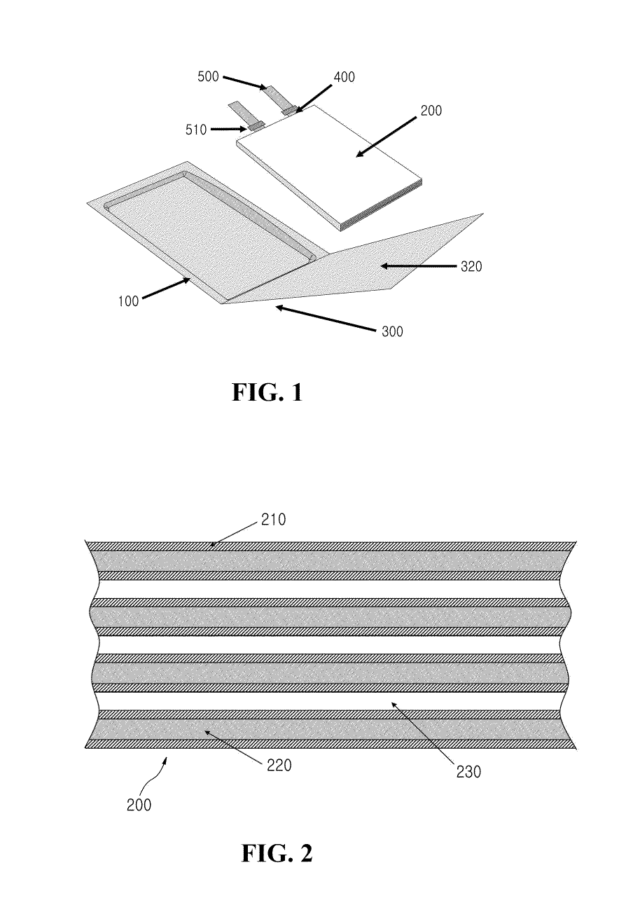

### DETAILED DESCRIPTION OF THE PREFERRED EMBODIMENT

A unit cell for a lithium ion secondary battery according to the present invention includes an electrode laminate 200 formed in such a manner that a unit including electrodes 220 and 230 and a separation layer 210 is repeatedly laminated, and at least one conductive sheet layer 240 located between specific layers of the electrode laminate 200 and electrically connected to an electrode lead.

Although the conductive sheet layer 240 may be formed of any conductive material such as metal and non-metal materials, it is preferable to form the conductive sheet layer 240 using at least one metal selected from a group consisting of aluminum, copper, nickel, iron, zinc, lead and titanium in terms of electrical conductivity. Furthermore, the conductive sheet layer 240 may be formed of aluminum when the conductive sheet layer 240 comes into contact with the positive electrode 220 and may be formed of copper when the conductive sheet layer 240 comes into contact with the negative electrode 230 because the battery can be easily manufactured and the safety of the battery can be improved when the conductive sheet layer 240 is formed of the same material as the electrode 220 or 230.

The conductive sheet layer 240 may have a thickness in the range of 0.001 to 200 mm. If the battery has a large capacity, the safety of the battery is improved as the thickness of the conductive sheet layer 240 increases. Accordingly, the thickness of the conductive sheet layer 240 can be increased for the large-capacity battery. In this case, multiple-plied conductive sheet may be used as the conductive sheet layer 240 to improve the safety of the battery. The size of the conductive sheet layer 240 is not limited. In general, the conductive sheet layer 240 has the same size of the electrode size, but the size ratio of the conductive sheet layer 240 to the electrode can be changed to the extent of process limit of the manufacturing the lithium ion secondary battery.

Furthermore, the number of conductive sheet layers used in the present invention is not limited. The number of conductive sheet layers used for the lithium ion secondary battery is determined according to electric conduction efficiency required when short-circuit of the battery occurs. And, the position of the conductive sheet layer 240 is not limited. The method of laminating the electrodes, the separation layer and the conductive sheet layer can use any one of the winding type that envelops the positive and negative electrodes in the separation layer and integrates the positive and negative electrodes and the stacking type that sequentially stacks the separation layer, the positive electrode and the negative electrode in a predetermined area.

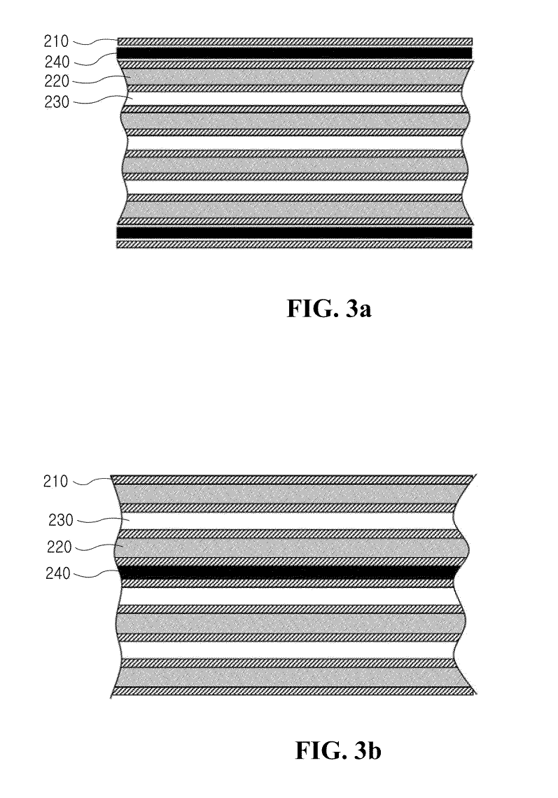

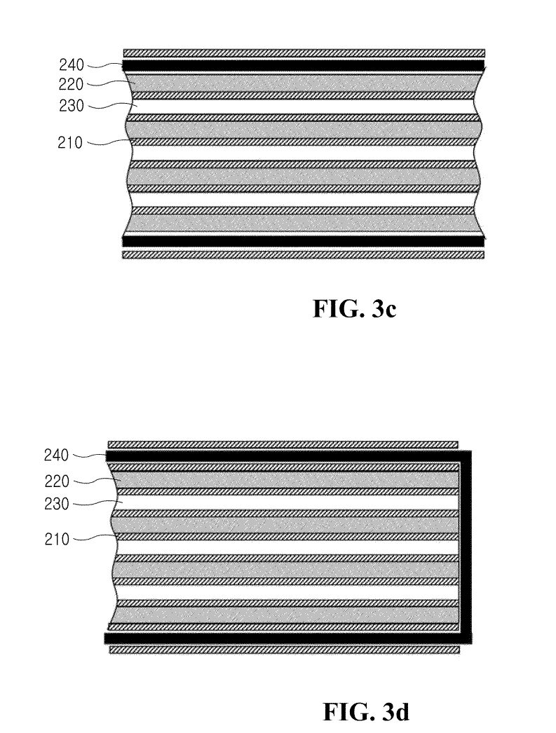

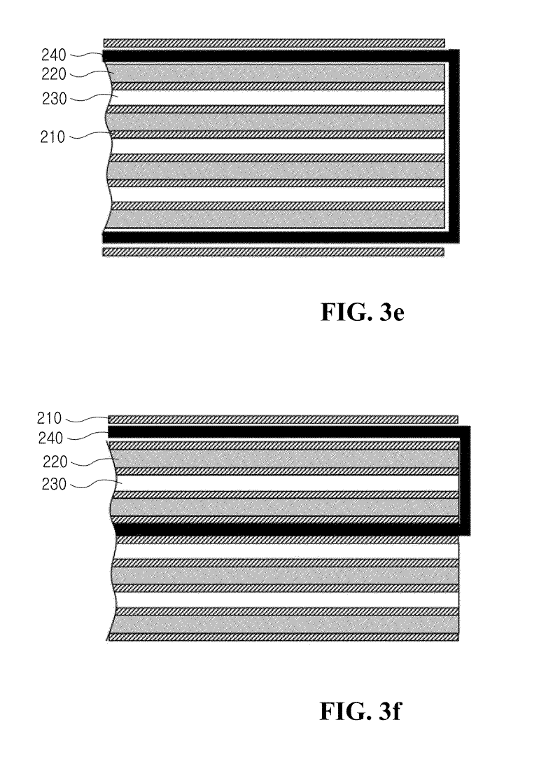

FIGS. 3a through 3f are cross-sectional views showing examples of locating the conductive sheet layer 240 according to the present invention between certain layers of the electrode laminate 200. Two conductive sheet layers 240 may be respectively inserted between two uppermost separation layers 210 and between two lowermost separation layers 210 (FIG. 3a); a single conductive sheet layer 240 may be located between separation layers 210 in the electrode laminate 200 (FIG. 3b); and two conductive sheet layers 240 may be respectively located between the uppermost separation layer 210 and an electrode 220 formed under the uppermost separation layer 210 and between the lowermost separation layer 210 and an electrode formed beneath the lowermost separation layer 210 (FIG. 3c). An appropriate locating position can be selected in view of the battery's structural limit, efficiency, etc. When the electrode laminate includes two or more conductive sheet layers 240, the ends of the conductive sheet layers 240 may be electrically connected using a conductive material identical to or different from the material of the conductive sheet layers 240 (FIGS. 3d, 3e and 3f).

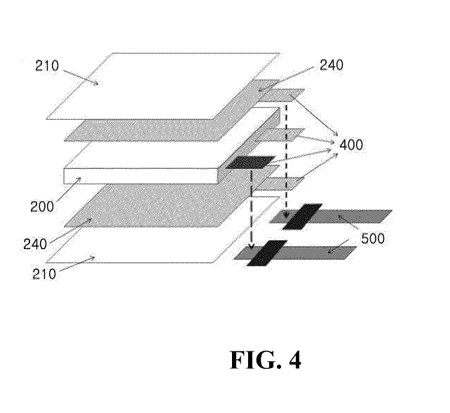

FIG. 4 shows connection of an electrode lead 400 and an electrode tap 500 to the unit cell having the electrode laminate 200 shown in FIG. 3a after the conductive sheet layer 240 is inserted into the electrode laminate 200. In FIG. 4, an electrode lead of the inserted conductive sheet layer 240 is connected to an electrode lead of the positive electrode. The electrode leads are further connected to an electrode tap of the positive pole. An electrode lead connected to the negative electrode is not connected to the conductive sheet layer 240, but is connected to an electrode tap of the negative pole. In this manner, the unit cell including the conductive sheet layer 240 is accomplished. The aforementioned method of connecting the electrode laminate 200 with the electrode lead and the electrode tap may be applied to the electrode laminates shown in FIGS. 3a through 3f and the conductive sheet layer 240 may be connected to the electrode lead of the negative pole instead of the electrode lead of the positive pole according to the type of the conductive sheet layer 240.

The present invention will now be described in detail by explaining embodiments of the invention. The invention may, however, be embodied in many different forms and should not be construed as being limited to the embodiments set forth herein.

### First Embodiment

Slurry is made by using lithium cobalt oxide(that is a lithium transition metal oxide, active material for positive electrode), carbon black conductive material, PVDF (Polyvinylidene Fluoride) binder and NMP (N-Methyl-Pyrrolidone) solution, coated on an aluminum current collector and dried to form a positive electrode. Slurry is made by using graphite powder, carbon black conductive material, PVDF binder and NMP solution, coated on a copper current collector and dried to form a negative electrode, and then an electrode tap is cut in a protruded form having a predetermined size.

The positive electrode and the negative electrode are stacked through a stacking method, having a multi-layered polyethylene porous layer interposed between the positive electrode and the negative electrode, to accomplish an electrode laminate forming a unit cell. Here, an aluminum sheet having a thickness of 0.1 mm is used as a conductive sheet layer. Two aluminum sheets are respectively inserted between two uppermost separation layers of the electrode laminate and between two lowermost separation layers of the electrode laminate, as shown in FIG. 3a. The aluminum sheets are connected to an electrode lead of an electrode located in an outer layer of the unit cell. After the unit cell is assembled, an electrode tap is attached to the electrode lead.

A receiving part having a recess in which the unit cell can be easily mounted is made of aluminum and a lid capable of covering the receiving part is formed to accomplish a pouch. Then, the unit cell is mounted in the aluminum pouch and faces of the pouch are sealed leaving only one face unsealed. The pouch containing the unit cell is dipped in an electrolyte composed of ethylene carbonate and LiPF₆ lithium salt for lithium ion secondary battery, which is dissolved in the ethylene carbonate, and sealed up in a vacuum state. Then, the pouch is aged such that the electrolyte sufficiently infiltrates into the electrodes of the unit cell to initially charge the unit cell and stabilized to produce a pouch type lithium ion secondary battery.

### Second Embodiment

The unit cell and the lithium ion secondary battery are formed through the same manufacturing method as the manufacturing method of the first embodiment except that a single aluminum sheet as a conductive sheet layer is inserted between separation layers located in the electrode laminate, as shown in FIG. 3b.

### Third Embodiment

The unit cell and the lithium ion secondary battery are formed through the same manufacturing method as the manufacturing method of the first embodiment except that two aluminum sheets as conductive sheet layers are respectively inserted between the uppermost separation layer and an electrode formed beneath the uppermost separation layer and between the lowermost separation layer and an electrode formed beneath the lowermost separation layer, as shown in FIG. 3c.

### Fourth Embodiment

The unit cell and the lithium ion secondary battery are formed through the same manufacturing method as the manufacturing method of the first embodiment except that two aluminum sheets are respectively inserted between two uppermost separation layers and between two lowermost separation layers, as described in the first embodiment, and the two aluminum sheets are electrically connected to each other at the side opposite to the electrode lead, as shown in FIG. 3d.

### Fifth Embodiment

The unit cell and the lithium ion secondary battery are formed through the same manufacturing method as the manufacturing method of the first embodiment except that two aluminum sheets are inserted in the same manner as that of the third embodiment and electrically connected to each other at the side opposite to the electrode lead.

### Sixth Embodiment

The unit cell and the lithium ion secondary battery are formed through the same manufacturing method as the manufacturing method of the first embodiment except that a metal sheet is inserted between two outermost separation layers, another metal sheet is inserted between two separation layers located in the electrode laminate, and the two metal sheets are electrically connected at the side opposite to the electrode lead.

### COMPARATIVE EXAMPLE

The unit cell and the lithium ion secondary battery are formed through the same manufacturing method as the manufacturing method of the first embodiment without inserting an aluminum sheet as a conductive sheet layer into the unit cell.

<Evaluation of Penetration>

The pouch type lithium ion secondary batteries according to the embodiments and the comparative example are charged and placed with the wider sides thereof facing upward, and then the centers of the wider sides of the pouch type lithium ion secondary batteries are pierced using a steel needle having a diameter of 5 mm at a predetermined speed to perform evaluation of penetration. The evaluation result is arranged in Table 1.

TABLE 1

| Test | | Embodiments | | | | | | Comparative |
|---|---|---|---|---|---|---|---|---|
| Condition | | 1 | 2 | 3 | 4 | 5 | 6 | Example |
| Φ5 | mm | No firing | No | No | No | No firing | No | No firing |
| 80 | mm/sec | | firing | firing | firing | | firing | |
| Φ5 | mm | No | No | No | No | No | No | Firing |
| 60 | mm/sec | firing | firing | firing | firing | firing | firing | |
| Φ5 | mm | No | No | No | No | No | No | Firing |
| 40 | mm/sec | firing | firing | firing | firing | firing | firing | |
| Φ5 | mm | No | No | No | No | Firing | No | Firing |
| 20 | mm/sec | firing | firing | firing | firing | | firing | |
| Φ5 | mm | No | No | Firing | No | Firing | Firing | Firing |
| 15 | mm/sec | firing | firing | | firing | | | |
| Φ5 | mm | Firing | Firing | Firing | No | Firing | Firing | Firing |
| 10 | mm/sec | | | | firing | | | |

It can be confirmed from Table 1 that no firing occurs even when the speed of the needle decreases to 20 mm/sec to increase internal short-circuiting time in the embodiments 1, 2, 3 and 4. In the embodiment 4, particularly, no firing occurs even though the speed of the needle decreases to 10 mm/sec. This is because the outermost metal sheet of the unit cell rapidly conducts current to the outside when pierced and the quantity of heat generated in the metal sheet is much smaller than the quantity of heat generated in positive and negative electrodes in the event of internal short-circuiting, and thus the battery safety is improved

In the embodiments 5 and 6, no firing occurs even when the speed of the needle decreases to 20 to 40 mm/sec to increase the internal short-circuiting time. The battery safety when the metal sheet is located in the unit cell is lower than the battery safety when the metal sheet is located at the outermost level of the unit cell. However, the safety of the lithium ion secondary battery is improved compared to the comparative example having no conductive sheet layer.

In the comparative example, it can be confirmed that firing occurs even at a high speed of 60 mm/sec.

While the present invention has been described with reference to the particular illustrative embodiments, it is not to be restricted by the embodiments but only by the appended claims. It is to be appreciated that those skilled in the art can change or modify the embodiments without departing from the scope and spirit of the present invention.

What is claimed is:

1. A unit cell for a lithium ion secondary battery comprising:
an electrode laminate formed in a manner that a plurality of unit structures are stacked, each of which includes at least one electrode and at least one separation layer; and
at least one conductive sheet layer located between certain layers in the electrode laminate and electrically connected to an electrode lead.

2. The unit cell of claim 1, wherein the conductive sheet layer is made of at least one metal selected from a group consisting of aluminum, copper, nickel, iron, zinc, lead and titanium.

3. The unit cell of claim 1, wherein the conductive sheet layer is made of aluminum when the conductive sheet layer comes into contact with a positive electrode and the conductive sheet layer is made of copper when the conductive sheet layer comes into contact with a negative electrode

4. The unit cell of claim 1, wherein the conductive sheet layer is a multi-plied sheet.

5. The unit cell of claim 1, wherein the conductive sheet layer has a thickness in the range of 0.001 to 200 mm.

6. The unit cell of claim 1, wherein the unit cell includes two or more conductive sheet layers and the conductive sheet layers are respectively located between the uppermost separation layer and uppermost electrode and between the lowermost separation layer and lowermost electrode.

7. The unit cell of claim 6, wherein the two or more conductive sheet layers are electrically connected at the side opposite to the electrode lead.

8. A lithium ion secondary battery including the unit cell according to claim 1.

9. A lithium ion secondary battery including the unit cell according to claim 2.

10. A lithium ion secondary battery including the unit cell according to claim 3.

11. A lithium ion secondary battery including the unit cell according to claim 4.

12. A lithium ion secondary battery including the unit cell according to claim 5.

13. A lithium ion secondary battery including the unit cell according to claim 6.

14. A lithium ion secondary battery including the unit cell according to claim 7.
